(19) United States
(12) Patent Application Publication
(10) Pub. No.: US 2008/0211830 A1
(43) Pub. Date: Sep. 4, 2008

(54) Apparatus and Method for Video Signal Conversion

(75) Inventors: Hirotoshi Abe, Kumagaya-shi (JP); Satoshi Hattori, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/021,121

(22) Filed: Jan. 28, 2008

(30) Foreign Application Priority Data
Jan. 31, 2007 (JP) 2007-022066

(51) Int. Cl. G09G 5/02

(52) U.S. Cl. 345/604

(57) ABSTRACT

According to one embodiment, there is provided a video signal conversion apparatus including a determination unit which receives a video signal to determine whether the video signal is an xvYCC standard video signal or a YC_{B}C_{R} standard video signal, a first conversion unit which converts the xvYCC standard video signal into an RGB standard video signal to output the RGB standard video signal when the determination unit determines that the video signal is the xvYCC standard video signal, and a second conversion unit which converts the YC_{B}C_{R} standard video signal into the RGB standard video signal to output the RGB standard video signal when the determination unit determines that the video signal is the YC_{B}C_{R} standard video signal.

### CROSS-REFERENCE TO RELATED APPLICATION

This application is based upon and claims the benefit of priority from Japanese Patent Application No. 2007-022066, filed Jan. 31, 2007, the entire contents of which are incorporated herein by reference.

### BACKGROUND

1. Field

One embodiment of the invention relates to a video signal conversion apparatus and a video signal conversion method for handling an xvYCC standard video signal.

2. Description of the Related Art

Recently, digital video apparatuses have become widespread, and many users can watch high-resolution and high-quality video image. Therefore, there is a need for richly-expressive color representation which has never been realized by a conventional CRT display device. There is well-known a color space standard called an xvYCC standard for a moving image. The xvYCC standard is broader than a conventional sRGB standard in the color space. For example, in comparison of a high-chroma color cascade called a Munsell color cascade, the xvYCC standard can support the 100% Munsell color cascade while the sRGB standard supports only the 55% Munsell color cascade.

Jpn. Pat. Appln. KOKAI Publication No. 2002-16874 discloses a technique of being able to select a color correction condition from a menu while gradation is reflected with respect to a particular target of image data taken by a digital camera.

However, unfortunately Jpn. Pat. Appln. KOKAI Publication No. 2002-16874 does not disclose how the xvYCC standard video signal is finally converted into an RGB standard video signal to display the image data on a current display screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of an RGB conversion unit which supports an xvYCC standard video signal handled by a video signal conversion apparatus according to an embodiment of the invention;

FIG. 2 is a block diagram showing another example (automatically selecting function) of the RGB conversion unit which supports the xvYCC standard video signal handled by the video signal conversion apparatus of the embodiment;

FIG. 3 is a flowchart showing an example of xvYCC standard video signal processing handled by the video signal conversion apparatus of the embodiment;

FIG. 4 is a simplified two-dimensional explanatory view of the xvYCC standard video signal handled by the video signal conversion apparatus of the embodiment;

FIG. 5A and FIG. 5B are explanatory views showing a relationship among a YC_{B}C_{R} standard video signal, the xvYCC standard video signal, and an RGB standard video signal which are handled by the video signal conversion apparatus of the embodiment;

FIG. 6 is a graph showing an example of an xvYCC standard video signal processing method (linear correction type) performed by the video signal conversion apparatus of the embodiment;

FIG. 7 is a graph showing an example of an xvYCC standard video signal processing method (nonlinear gamma correction type/immovable changing point) performed by the video signal conversion apparatus of the embodiment;

FIG. 8 is a graph showing an example of an xvYCC standard video signal processing method (nonlinear gamma correction type/movable changing point) performed by the video signal conversion apparatus of the embodiment;

FIG. 9 is a graph showing an example of an xvYCC standard video signal processing method (correction off) performed by the video signal conversion apparatus of the embodiment;

FIG. 10 is a block diagram showing an example of a configuration of a video display apparatus including the video conversion unit of the embodiment;

FIG. 11 is an explanatory view showing an example of HDMI standard communication between a source and a sink concerning the video signal conversion apparatus of the embodiment;

FIG. 12 is an explanatory view showing an example of an HDMI standard operating mode concerning the video signal conversion apparatus of the embodiment;

FIG. 13 is an explanatory view showing an example of an HDMI standard packet header concerning the video signal conversion apparatus of the embodiment;

FIG. 14 is an explanatory view showing an example of an HDMI standard Packet Type concerning the video signal conversion apparatus of the embodiment;

FIG. 15 is an explanatory view showing an example of an HDMI standard AVI InfoFrame data concerning the video signal conversion apparatus of the embodiment; and

FIG. 16 is an explanatory view showing an example of color space data in the HDMI standard AVI InfoFrame data concerning the video signal conversion apparatus of the embodiment.

### DETAILED DESCRIPTION

Various embodiments according to the invention will be described hereinafter with reference to the accompanying drawings. In general, according to one embodiment of the invention, there are provided a video signal conversion apparatus and a video signal conversion method for converting a given xvYCC standard video signal into the RGB standard video signal to display the image data on the display screen.

One embodiment for achieving the object is a video signal conversion apparatus comprising:

a determination unit which receives a video signal to determine whether the video signal is an xvYCC standard video signal or a YC_{B}C_{R} standard video signal;

a first conversion unit which converts the xvYCC standard video signal into an RGB standard video signal to output the ROB standard video signal when the determination unit determines that the video signal is the xvYCC standard video signal; and

a second conversion unit which converts the YC_{B}C_{R} standard video signal into the ROB standard video signal to output the ROB standard video signal when the determination unit determines that the video signal is the YC_{B}C_{R} standard video signal.

Therefore, the RGB standard video signal can be provided to display the video image compatible with the xvYCC standard video signal having the color space broader than that of the conventional sRGB standard on the display screen.

An embodiment of the invention will be described in detail with reference to the accompanying drawings.

<An Example of Video Signal Conversion Apparatus according to One Embodiment of the Invention>

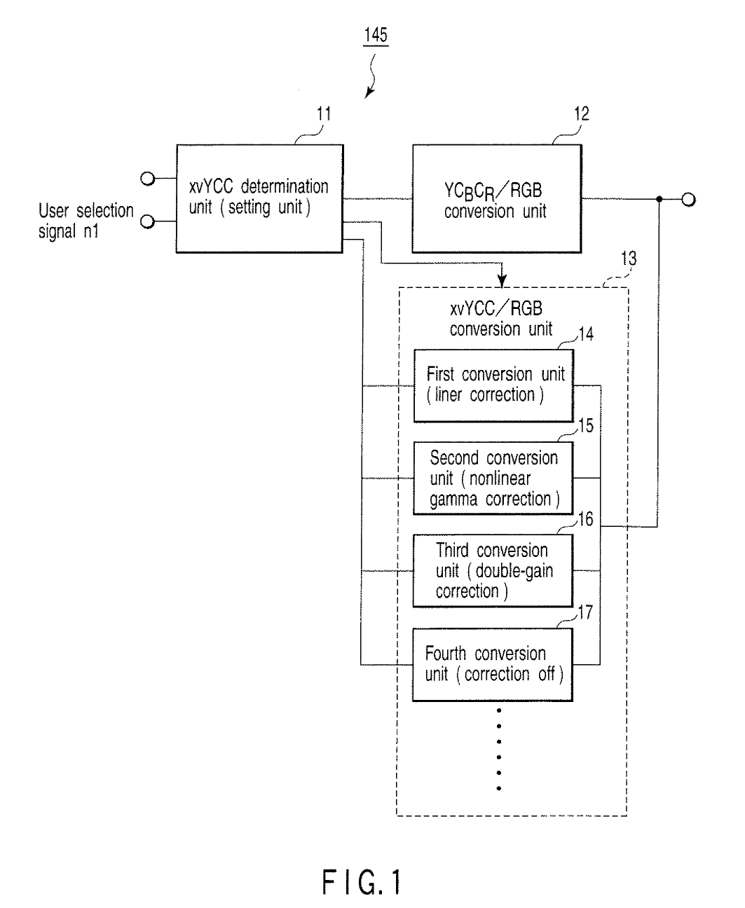

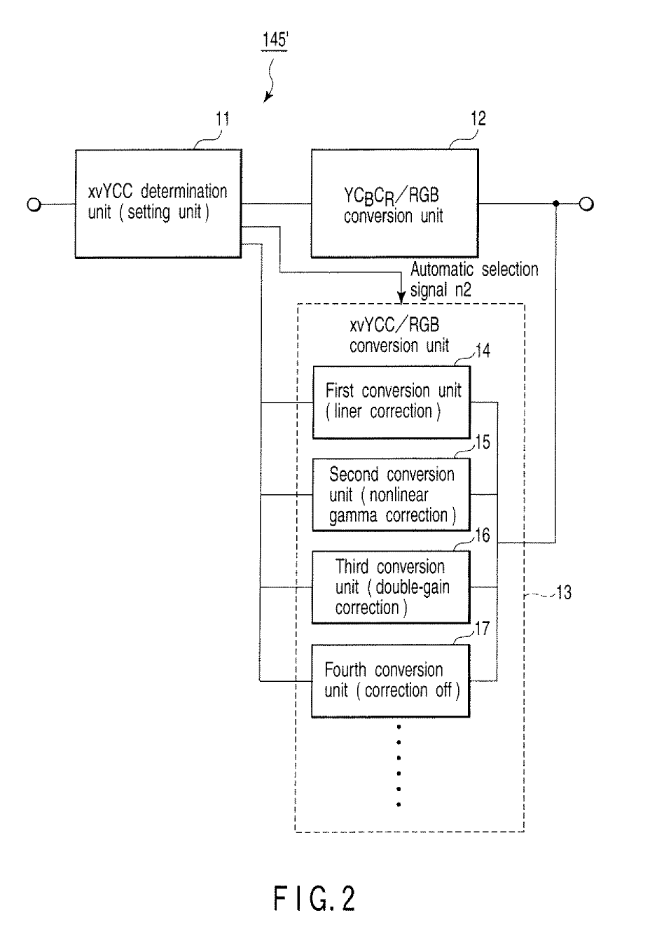

A video signal conversion apparatus according to one embodiment of the invention will be described in detail below with reference to the drawings. FIG. 1 is a block diagram showing an example of an RGB conversion unit which supports an xvYCC standard video signal handled by the video signal conversion apparatus according to an embodiment of the invention, and FIG. 2 is a block diagram showing another example of the RGB conversion unit which supports the xvYCC standard video signal handled by the video signal conversion apparatus of the embodiment.

(Configuration)

As shown in FIG. 1, a xvYCC supporting RGB conversion unit 145 of the embodiment includes an xvYCC determination unit 11 which has a setting function of specifying one conversion method from plural conversion methods, a YC_{B}C_{R}/RGB conversion unit 12 which converts the YC_{B}C_{R} standard video signal into the RGB standard video signal, and an xvYCC/RGB conversion unit 13. The video signal and a selection signal 11 are supplied to the xvYCC determination unit 11. The selection signal n1 is used to select one conversion unit from the plural conversion units given by user operation.

The xvYCC/RGB conversion unit 13 includes at least a first conversion unit 14, a second conversion unit 15, a third conversion unit 16, and a fourth conversion unit 17. Detailed functions of the conversion units 14 to 17 will be described later.

At this point, the converting function of the YC_{B}C_{R}/RGB conversion unit 12 is described by the following equations (1) to (3). The equations (1) to (3) describe relationships between an R signal, a G signal, and a B signal, and a Y signal, a C_{B} signal, and a C_{R} signal of the YC_{B}C_{R} standard video signal.

$$\begin{matrix}R = 1 \times Y + 0 \times {C}_{B} - 1.574801 \times {C}_{R} & ( 1 ) \\ G = 1 \times Y - 0.187324 \times {C}_{B} - 0.468124 \times {C}_{R} & ( 2 ) \\ B = 1 \times Y + 1.855601 \times {C}_{B} + 0 \times {C}_{R} & ( 3 )\end{matrix}$$

(Other Configuration: Automatically Selecting Function)

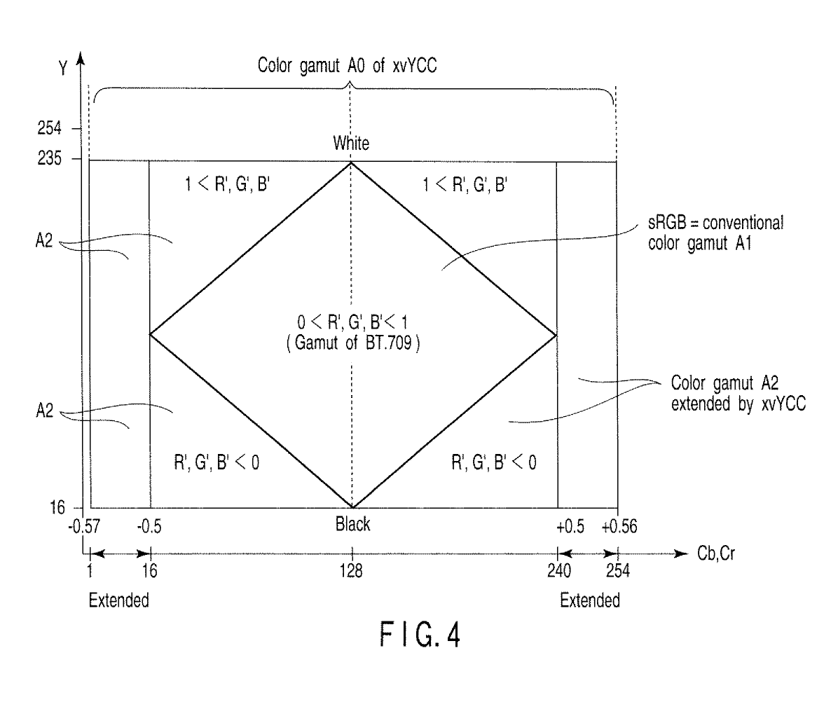

Another example (automatically selecting function) of the xvYCC standard video signal supporting RGB conversion unit handled by the video signal conversion apparatus of the embodiment will be described with reference to FIG. 2. An RGB conversion unit 145′ of FIG. 2 has substantially the same configuration as the RGB conversion unit 145 of FIG. 1. However, in the RGB conversion unit 145′, a signal distribution of the given video signals is detected, and an automatic selection signal n2 for automatically selecting one of the first to fourth conversion units 14 to 17 is supplied to the xvYCC/RGB conversion unit 13 based on the signal distribution. For a criterion of the selection, preferably the conversion unit is determined based on how much amount of intrinsic color signal component (see FIG. 4) of the xvYCC standard video signal is included in the xvYCC standard video signal. The intrinsic color signal component of the xvYCC standard video signal is not included in the YC_{B}C_{R} standard video signal.

(Operation)

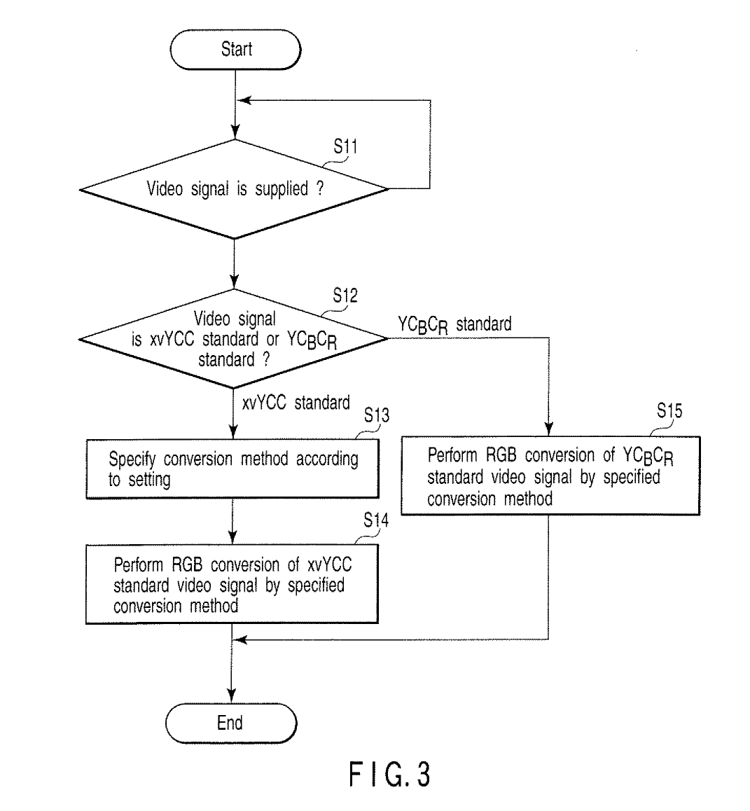

A conversion processing performed by the RGB conversion unit 145 will be described in detail with reference to a flowchart of FIG. 3. Each step of the flowchart shown in FIG. 3 can be replaced by a circuit block, so that the steps of the flowchart can be re-defined as blocks. Additionally, the steps of the flowchart can be realized by a program and a configuration of a microcomputer having a CPU for processing the program.

When the video signal is supplied to the xvYCC determination unit 11 (Step S11), the xvYCC determination unit 11 determines whether the supplied video signal is the xvYCC standard video signal or the YC_{B}C_{R} standard video signal (Step S12). Although various techniques of making the determination of the video signal can be adopted, preferably the video signal is observed for a predetermined period, and then the determination is made based on where the video signals are distributed in a color gamut of the color space of FIG. 4.

When the given video signals are distributed over a color gamut A0, particularly when at least a predetermined amount of signals is distributed in a color gamut A2, it can be determined that the given video signals are the xvYCC standard video signal. On the contrary, when the given video signals are distributed only in a color gamut A1 and, at the same time, when the signals of up to the predetermined amount exist in the color gamut A2, it can be determined that the given video signals are the YC_{B}C_{R} standard video signal.

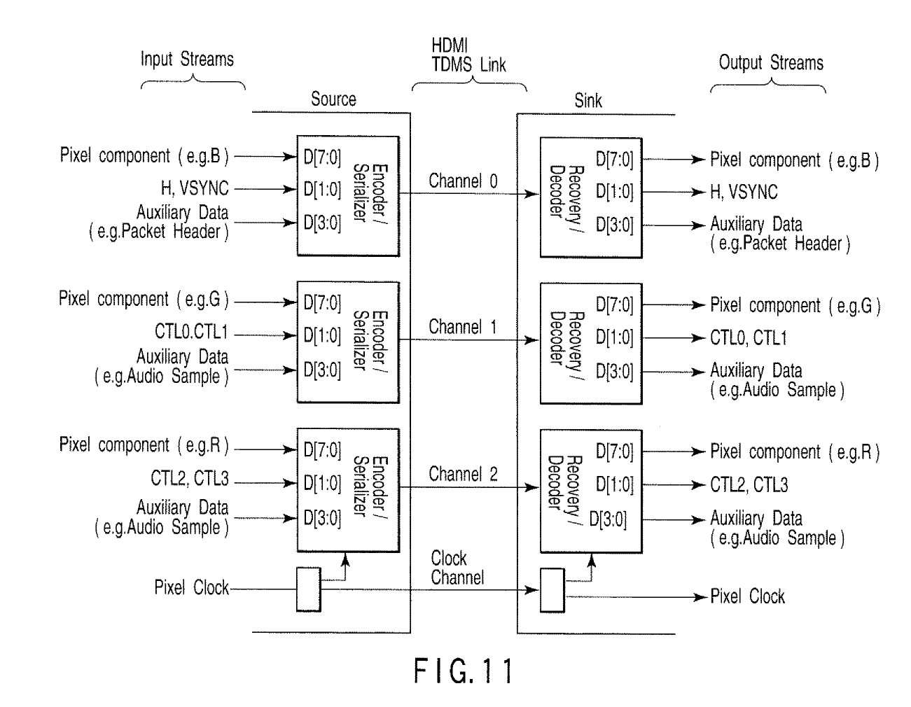

As described later with reference to FIGS. 11 to 16, it is preferable to make a determination of a kind of the given video signal based on an HDMI (High-Definition Multimedia Interface) discrimination signal.

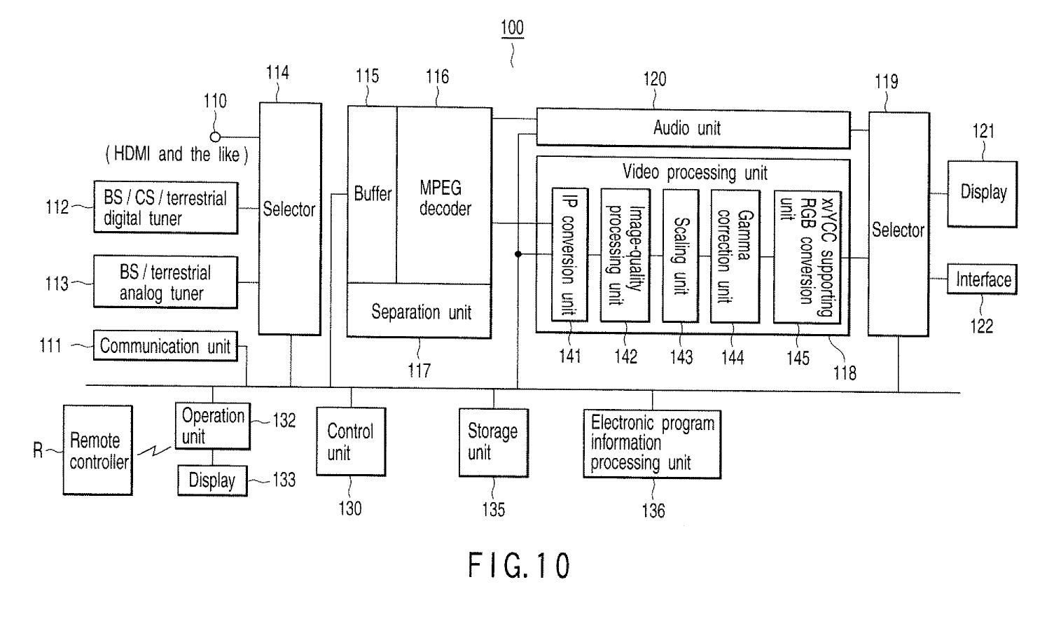

Thus, when the xvYCC determination unit 11 determines that the given video signal is the xvYCC video signal, a conversion method is specified according to the setting (Step S13). Preferably one of the first to fourth conversion units 14 to 17 is set using a dip switch (not shown) incorporated in the xvYCC determination unit 11. Alternatively, one of the first to fourth conversion units 14 to 17 may be selected by the user selection signal n1. Preferably one of the first to fourth conversion units 14 to 17 is selected using an automatically selecting function of the xvYCC determination unit 11 as shown in FIG. 2. Preferably one of the first to fourth conversion units 14 to 17 is specified from candidates displayed on a display 133 using an operation unit 132 of a broadcast receiving apparatus 100 of FIG. 10 by the user operation (Step S13).

Then, the given xvYCC standard video signal is converted by one of the first to fourth conversion units 14 to 17, which is specified in the xvYCC/RGB conversion unit 13 (Step S14).

On the other hand, in Step S12, when the xvYCC determination unit 11 determines that the given video signal is the YC_{B}C_{R} standard video signal, the YC_{B}C_{R} standard video signal is converted into the RGB standard video signal according to the equations (1) to (3) and the RGB standard video signal is outputted (Step S15).

The xvYCC standard video signal and conversion processing performed by the xvYCC/RGB conversion unit 13 will be briefly described below.

(xvYCC Standard Video Signal)

The xvYCC standard video signal is an international standard color space which was approved at TEC (International Electrotechnical Commission) in October of 2005, and an official name for the xvYCC standard video signal is “IEC61966-2-4”. The color space, in which most “object colors” existing in nature and recognizable by human eyes, is defined in the xvYCC standard video signal. The xvYCC standard video signal also supports the “substantially 100%” representation of the Munsell color cascade (color chart shown in a Munsell book devised by A. H. Munsell) which indicates the kind of the object color.

FIG. 4 is a simplified two-dimensional explanatory view of the xvYCC standard video signal handled by the video signal conversion apparatus of the embodiment. The conventional sRGB space and the xvYCC color space will be described with reference to FIG. 4. The conventional sRGB color gamut A1 and the color gamut A2 extended by the xvYCC standard video signal are defined with respect to the xvYCC color gamut A0.

(YC_{B}C_{R} Standard Video Signal/xvYCC Standard Video Signal)

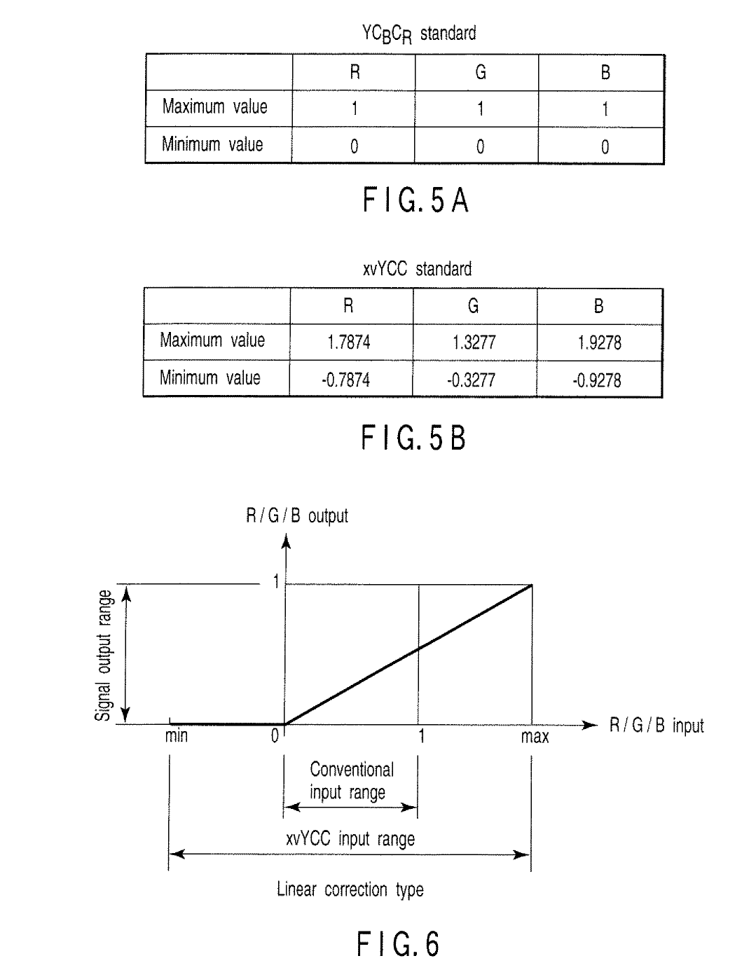

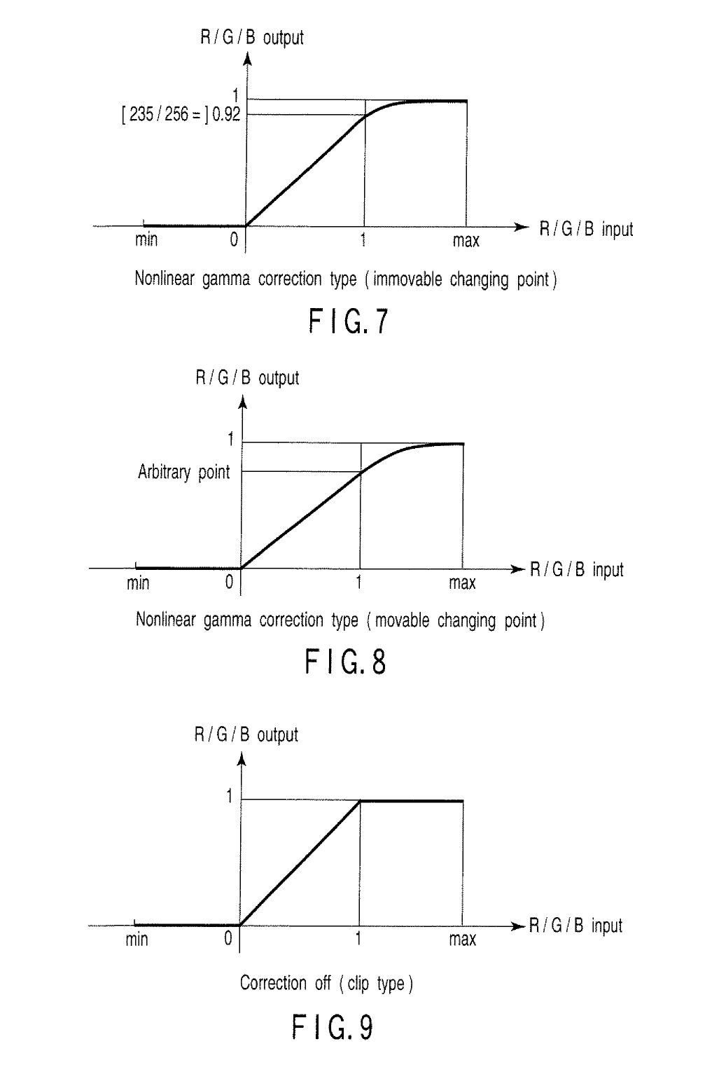

FIG. 5A and FIG. 5B are explanatory views showing a relationship among a YC_{B}C_{R} standard video signal, the xvYCC standard video signal, and an RGB standard video signal which are handled by the video signal conversion apparatus of the embodiment.

In the conventional YC_{B}C_{R} standard video signal shown in FIG. 5A, the color conversion is performed to the R signal within a range of the minimum value of “0” to the maximum value of “1”. Similarly, the color conversion is performed to the C signal within a range of the minimum value of “0” to the maximum value of “1”. Similarly, the color conversion is performed to the B signal within a range of the minimum value of “0” to the maximum value of “1”.

However, when the xvYCC standard video signal shown in FIG. 5B is converted into the RGB standard signal by the conventional technique (equations (1) to (3)), because at least the color gamut A2 extended by the xvYCC standard video signal exists as shown in FIG. 4, similarly the color conversion is performed to the R signal within a range of the minimum value of “−0.7874” to the maximum value of “1.7874”. The color conversion is performed to the G signal within a range of the minimum value of “−0.3277” to the maximum value of “1.3277”. The color conversion is performed to the B signal within a range of the minimum value of “−0.9278” to the maximum value of “1.9278”.

<Operation of xvYCC/RGB Conversion Unit>

The operation of each unit in the xvYCC/RGB conversion unit 13 shown in FIG. 1 and the like will be described in detail. When the xvYCC standard video signal is directly converted by the equations (1) to (3), the minimum value and the maximum value of the xvYCC standard video signal range from −0.9 to 1.9 such that the values do not fall within the range of “0” to “1” as shown in the table of FIG. 5B. Therefore, plural conversion methods (input RGB is converted into output RGB) for keeping the values within the range of “0” to “1” are devised as follows.

(First Conversion Unit: Linear correction Type)

The conversion processing performed by the first conversion unit 14 is called a linear correction type.

That is, linear correction is performed between “0” and the maximum value of the RGB signal of the xvYCC standard video signal. In the xvYCC standard video signal, the output RGB signal is clipped to “0” when the input ROB signal is not more than “0” after the conversion of the equations (1) to (3), and the output RGB signal is linearly proportional to the input RGB signal when the input RGB signal is not lower than “0” after the conversion of the equations (1) to (3).

(Second Conversion Unit: Nonlinear Gamma Correction Type (Immovable Changing Point))

The conversion processing performed by the second conversion unit 15 is called a nonlinear gamma correction type.

The changing point is immovable. In the xvYCC standard video signal, the output RGB signal is clipped to “0” when the input RGB signal is not more than “0” after the conversion of the equations (1) to (3), and the linear correction is performed when the input RGB signal ranges from “0” to “0.92”. In the range in which the input RGB signal is not lower than “1”, the gamma correction data is previously prepared to perform nonlinear gamma correction. The point at which the input RGB signal after the conversion corresponds to “1” is fixed to a point (235 in 256) which is located out of the conventional type.

(Third Conversion Unit: Nonlinear Gamma Correction Type (Movable Changing Point))

The conversion processing performed by the third conversion unit 16 is called the nonlinear gamma correction type.

The changing point is movable. In the xvYCC standard video signal, the output RGB signal is clipped to “0% when the input RGB signal is not more than “0” after the conversion of the equations (1) to (3), and the linear correction is performed when the input RGB signal ranges from >0” to an “arbitrary value”. In the range in which the input RGB signal is not lower than “1”, the gamma correction data is previously prepared to perform the nonlinear gamma correction. The point at which the input RGB signal corresponds to “1” is appropriately changed as “arbitrary value”.

(Fourth Conversion Unit: Correction Off)

The conversion processing performed by the fourth conversion unit 17 is called correction off (clip type)

In this case, the intrinsic conversion processing is not performed to the xvYCC standard video signal. For the input RGB signal in which the YC_{B}C_{R} standard video signal is processed by the equations (1) to (3), the output RGB signal is clipped to “0” when the input RGB signal is not more than “0” after the conversion. Similarly, the output RGB signal is clipped to “1” when the input RGB signal is not lower than “1” after the conversion.

The conversion processing performed by the first to fourth conversion units or the processing based on the conversion processing is selected according to user setting or specified by a value previously given as a default. The ROB conversion processing of the YC_{B}C_{R} standard video signal is performed by the selected one piece of conversion processing. Therefore, the well-balanced video image can be displayed for the YC_{B}C_{R} standard video signal which has not been sufficiently displayed by the conventional technique.

<Broadcast Receiving Apparatus including xvYCC supporting RGB Conversion Unit according to One Embodiment of the Invention>

An example of a broadcast receiving apparatus in which the xvYCC supporting RGB conversion unit is used will be described in detail with reference to the drawings.

(Configuration and Operation of Broadcast Receiving Apparatus)

FIG. 10 is a block diagram showing an example of a configuration of a broadcast receiving apparatus including the gamma correction circuit of the embodiment. As shown in FIG. 10, a broadcast receiving apparatus 100 is a television receiving apparatus in which a control unit 130 is connected to each unit through a data bus to control the entire operation.

The broadcast receiving apparatus 100 in FIG. 10 mainly includes an MPEG decoder 116 which constitutes a reproduction side and the control unit 130 which controls the operation of the apparatus main body. The broadcast receiving apparatus 100 includes an input-side selector 114 and an output-side selector 119. An input unit 110 including HDMI, a BS/CS/terrestrial digital tuner 112, and a BS/terrestrial analog tuner 113 are connected to the input-side selector 114. A communication unit 111 having a LAN or mailing function is connected to the control unit 130 through a main cable.

The broadcast receiving apparatus 100 also includes a storage unit 135 and an electronic program information processing unit 136. Video information from the MPEG decoder 116, a separation unit 117, and the tuner is appropriately recorded in the storage unit 135. The electronic program information processing unit 136 obtains electronic program information from a broadcast signal to display the electronic program information on the screen. Each unit is connected to the control unit 130 through the data bus. The output of the selector 119 is connected to a display 121 and supplied to an external device through an interface 122 which communicates with the external device.

The broadcast receiving apparatus 100 also includes the operation unit 132 which is connected to the control unit 130 through the data bus to receive the user operation or the operation of a remote controller R. In the remote controller R, substantially the same operation as the operation unit 132 provided in the main body of the broadcast receiving apparatus 100 can be performed. A tuner operation and various settings can be performed in the remote controller R.

In the broadcast receiving apparatus 100, the broadcast signal is inputted through a receiving antenna to the tuners 112 and 113, which perform channel tuning. Decoding processing is performed to the tuned video and audio signal by the MPEG decoder 116 and the decoded video and audio signal is supplied to a video processing unit 118. The video processing unit 118 includes an IP conversion unit 141 which converts an interlace signal into a progressive signal, an image-quality processing unit 142 which performs coring processing and enhancement processing, a scaling unit 143 which performs scaling processing, a gamma correction unit 144 which performs video signal gamma correction, and an xvYCC supporting RGB conversion unit 145.

These input signals are managed by the control unit 130, and the input signals are switched to the signal inputted to the video processing unit 118. The operation signal is supplied from the remote controller R to the control unit 130 through the operation unit 132 to perform the channel tuning or input switching, which controls the MPEG decoder 116 or the video processing unit 118. The video signal processed by the video processing unit 118 is displayed on the display 121 through the selector 119. An audio signal is also supplied to a speaker (not shown).

As described above in detail, in the embodiment of the invention, when not only the YC_{B}C_{R} standard video signal but also the xvYCC standard video signal is given, the well-balanced color representation can be displayed on the display 121 such as a flat panel display by performing the proper RGB conversion processing.

<xvYCC Standard Video Signal Discrimination Method Using HDMI Discrimination Signal>

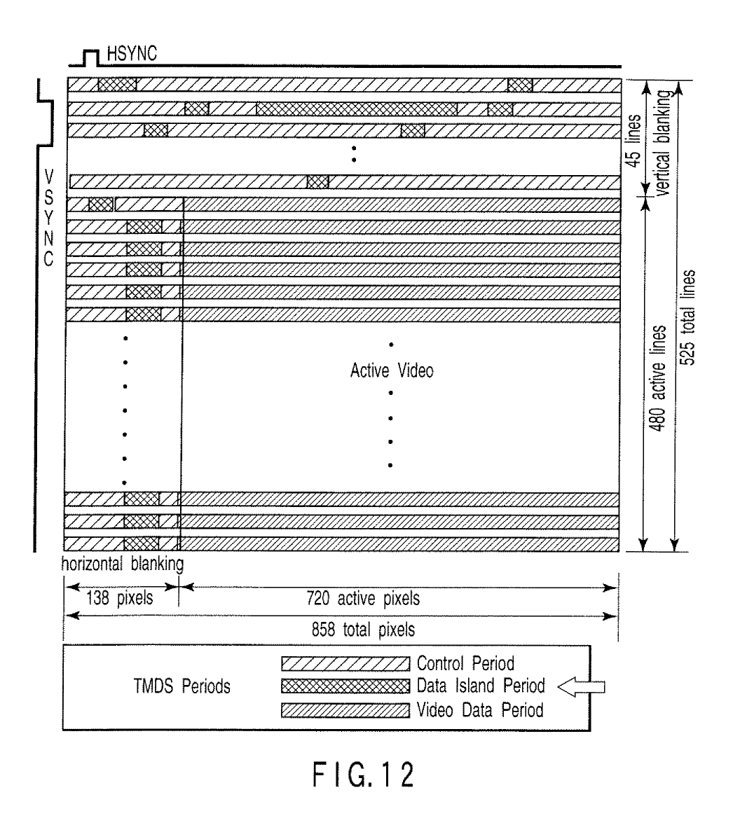

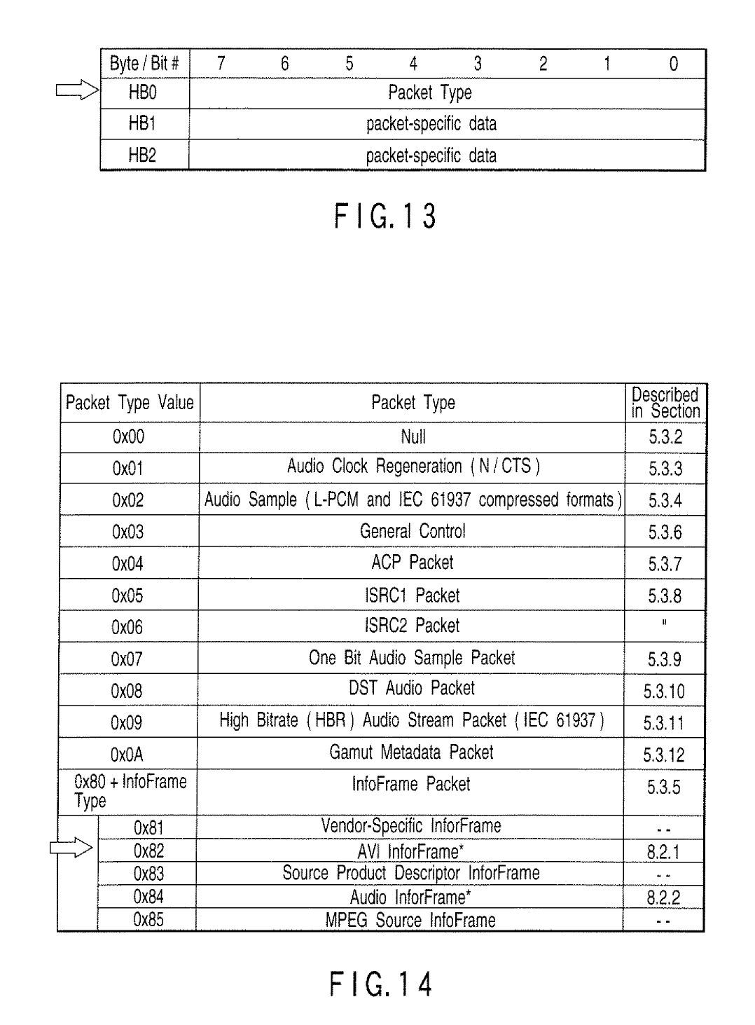

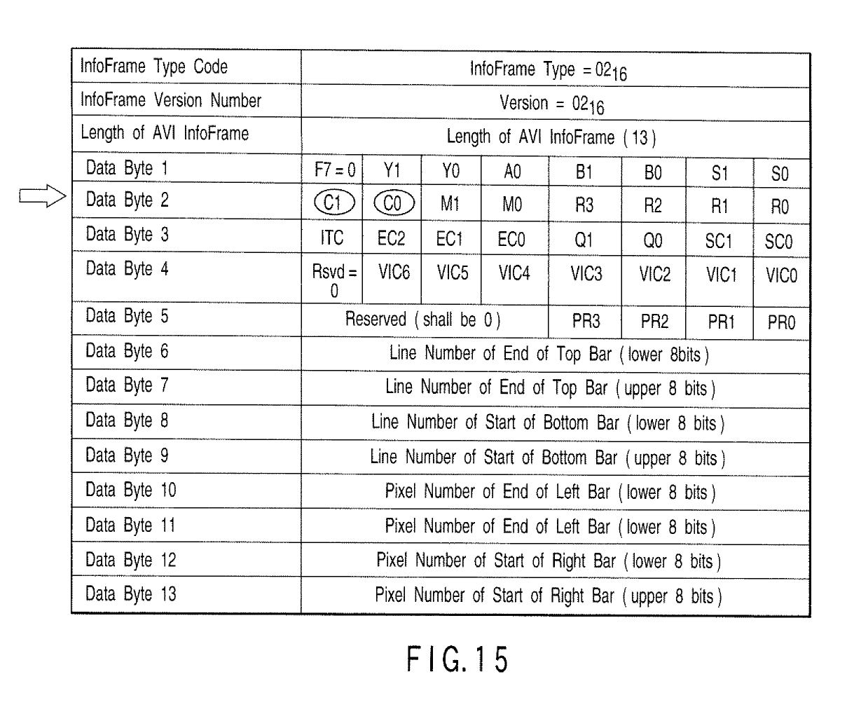

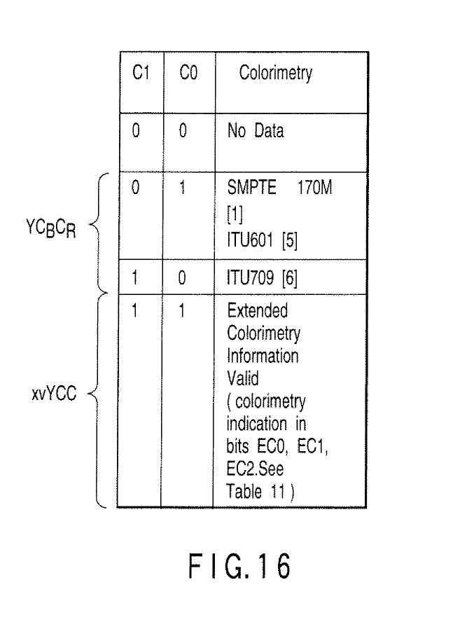

An xvYCC standard video signal discrimination method in which an HDMI discrimination signal is utilized will be described in detail with reference to FIGS. 11 to 16. FIG. 11 is an explanatory view showing an example of HDMI standard communication between a source and a sink concerning the video signal conversion apparatus of the embodiment, and FIG. 12 is an explanatory view showing an example of an HDMI standard operating mode concerning the video signal conversion apparatus of the embodiment. FIG. 13 is an explanatory view showing an example of an HDMI standard packet header concerning the video signal conversion apparatus of the embodiment, and FIG. 14 is an explanatory view showing an example of an HDMI standard Packet Type concerning the video signal conversion apparatus of the embodiment. FIG. 15 is an explanatory view showing an example of an HDMI standard AVI InfoFrame data concerning the video signal conversion apparatus of the embodiment, and FIG. 16 is an explanatory view showing an example of color space data in the HDMI standard AVI InfoFrame data concerning the video signal conversion apparatus of the embodiment.

The packet header of the HDMI standard includes a video signal discrimination signal, and the discrimination signal is distinguished by the xvYCC determination unit 11, whereby it can be determined that the video signal is the xvYCC standard video signal or the YC_{B}C_{R} standard video signal.

When the communication is conducted between a source side and a sink side in the HDMI standard shown in FIG. 11, Data Island Periods (arrow) specified by the operating mode shown in FIG. 12 exist in vertical blanking and horizontal blanking periods. A packet header shown in FIG. 13 is included in Data Island Period, and attention is given to “Packet Type” of HB0 (arrow).

In Packet Type of FIG. 14, “0x82” (arrow) means “AVI InfoFrame”, and when “C1” and “C0” values of “Data Byte 2” (arrow) of FIG. 15 are (C1,C0)=(0,1) or (1,0) as defined in FIG. 16, the given video signal means the YC_{B}C_{R} standard video signal.

Similarly, in the case of (C1,C0)=(1,1), it is found that the given video signal is the xvYCC standard video signal.

Therefore, the xvYCC determination unit 11 determines whether the video signal is the xvYCC standard video signal or the YC_{B}C_{R} standard video signal.

Thus, as described above in detail, the video signal conversion apparatus of the embodiment determines whether the given video signal is the xvYCC standard video signal or the conventional YC_{B}C_{R} standard video signal, and the video signal conversion apparatus displays the determined video signal on the screen with the appropriate color balance by the conversion method specified by the user.

Those skilled in the art can implement the invention by the various embodiments described above, and it is further understood by those skilled in the art that various changes and modifications can easily be made without departing from the scope of the invention, which can be applied to various embodiments without inventive ability. Accordingly, the invention covers the broad range which is consistent with the disclosed principle and the novel feature, and the invention is not limited to the embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal conversion apparatus comprising:
a determination unit which receives a video signal to determine whether the video signal is an xvYCC standard video signal or a YC_{B}C_{R} standard video signal;
a first conversion unit which converts the xvYCC standard video signal into an RGB standard video signal to output the RGB standard video signal when the determination unit determines that the video signal is the xvYCC standard video signal; and
a second conversion unit which converts the YC_{B}C_{R} standard video signal into the RGB standard video signal to output the RGB standard video signal when the determination unit determines that the video signal is the YC_{B}C_{R} standard video signal.

2. The video signal conversion apparatus according to claim 1, wherein the first conversion unit receives an instruction signal from an outside to select one of a plurality of conversion methods, and converts the xvYCC standard video signal into the ROB standard video signal based on the selected conversion method.

3. The video signal conversion apparatus according to claim 1, wherein a signal distribution of the video signals is detected, one of a plurality of conversion methods is selected based on the signal distribution, and the xvYCC standard video signal is converted into the RGB standard video signal based on the selected conversion method.

4. The video signal conversion apparatus according to claim 1, wherein the determination unit determines whether the video signal is the xvYCC standard video signal or the YC_{B}C_{R} standard video signal based on the video signal.

5. The video signal conversion apparatus according to claim 1, wherein the first conversion unit performs conversion processing for converting the YC_{B}C_{R} standard video signal into the RGB standard video signal to the xvYCC standard video signal, and further performs linear correction type conversion to the RGB standard video signal after the conversion, the first conversion unit converting the RGB standard video signal into zero after the conversion when the RGB standard video signal is not more than zero and the first conversion unit converting the RGB standard video signal into a signal having magnitude proportional to the RGB standard video signal after the conversion when the RGB standard video signal is not less than zero in the linear correction type conversion.

6. The video signal conversion apparatus according to claim 1, wherein the first conversion unit performs conversion processing for converting the YC_{B}C_{R} standard video signal into the RGB standard video signal to the xvYCC standard video signal, and further performs nonlinear gamma correction type conversion to the RGB standard video signal after the conversion, the first conversion unit converting the RGB standard video signal into zero after the conversion when the RGB standard video signal is not more than zero, the first conversion unit converting the RGB standard video signal into a signal having magnitude proportional to the RGB standard video signal after the conversion when the RGB standard video signal ranges from zero to a predetermined value, the first conversion unit converting the RGB standard video signal into “0.92” when the RGB standard video signal is “1”, and the is first conversion unit converting the RGB standard video signal into a previously-prepared gamma correction value when the RGB standard video signal is “1” or more in the nonlinear gamma correction type conversion.

7. The video signal conversion apparatus according to claim 1, wherein the first conversion unit performs conversion processing for converting the YC_{B}C_{R} standard video signal into the RGB standard video signal to the xvYCC standard video signal, and further performs nonlinear gamma correction type conversion to the RGB standard video signal after the conversion, the first conversion unit converting the RGB standard video signal into zero after the conversion when the RGB standard video signal is not more than zero, the first conversion unit converting the RGB standard video signal into a signal having magnitude proportional to the RGB standard video signal after the conversion when the RGB standard video signal ranges from zero to a predetermined value, the first conversion unit converting the RGB standard video signal into an “arbitrary value” when the RGB standard video signal is “1”, and the first conversion unit converting the RGB standard video signal into a previously-prepared gamma correction value when the RGB standard video signal is “1” or more in the nonlinear gamma correction type conversion.

8. The video signal conversion apparatus according to claim 1, wherein the first conversion unit performs conversion processing for converting the YC_{B}C_{R} standard video signal into the RGB standard video signal to the xvYCC standard video signal, converts the RGB standard video signal into zero after the conversion when the RGB standard video signal is not more than zero, keeps the RGB standard video signal constant after the conversion when the RGB standard video signal ranges from zero to 1, and converts the RGB standard video signal into 1 after the conversion when the RGB standard video signal is 1 or more.

9. The video signal conversion apparatus according to claim 1, further comprising:
a tuner which receives a broadcast signal to output a demodulated video signal to the determination unit and the first conversion unit or second conversion unit; and
a video display which displays a video image on a screen based on the RGB standard video signal outputted from the first conversion unit or second conversion unit.

10. A video signal conversion method comprising:
receiving a video signal;
determining whether the video signal is an xvYCC standard video signal or a YC_{B}C_{R} standard video signal;
converting the xvYCC standard video signal into an RGB standard video signal to output the RGB standard video signal when it is determined that the video signal is the xvYCC standard video signal; and
converting the YC_{B}C_{R} standard video signal into the RGB standard video signal to output the RGB standard video signal when it is determined that the video signal is the YC_{B}C_{R} standard video signal.
